(19) United States
(12) Patent Application Publication
(10) Pub. No.: US 2002/0002579 A1
(43) Pub. Date: Jan. 3, 2002

(54) System and method for providing services using a Web hub

(76) Inventors: Guy David Holden, Kingsport, TN (US); Mark Valentine Klopp, Danville, CA (US); Anthony Lettich, Johnson City, TN (US); Mark Bledsoe, Weber City, VA (US)

Correspondence Address: Charles Calkins, Kilpatrick Stockton LLP, 1001 West Fourth Street, Winston-Salem, NC, 27101, US

(21) Appl. No.: 09/803,987

(22) Filed: Mar. 13, 2001

Related U.S. Application Data
(60) Provisional application No. 60/189,157, filed on Mar. 14, 2000.

(51) Int. Cl. G06F 15/16

(52) U.S. Cl. 709/200

(57) ABSTRACT

A system and method for facilitating and managing relationships between and among companies and service providers that seeks to minimize and overcome the problems and inefficiencies of traditional methods is provided. The present invention integrates services that are currently provided by multiple entities into a unified system that may be advantageously provided by a single entity to facilitate the buying and selling of services and products. An embodiment of the present invention as a business to business (B2B) site on the World Wide Web (WWW) provides suppliers and customers in an industry with “one stop” to locate services that will facilitate their interactions. The present invention is particularly advantageous for use in providing services to the chemical industry. A community of service providers, companies and partners interact with each other utilizing a hub-based model. In one embodiment, the community comprises an industry such as the chemical industry. The community, however, may exist on many levels and comprise an entire industry on one level and segments of that industry on other levels. The community may be implemented as a “virtual” community, for example as a site on a computer network such as the World Wide Web; a corporate intranet; a government/military network or the like. Preferably, for ease of access to the widest number of participants, the virtual community is implemented as a site on the World Wide Web (Internet).

### CROSS-REFERENCE TO RELATED APPLICATIONS

This application claims priority to U.S. Provisional patent application Ser. No. 60/189,157, filed Mar. 14, 2000 by G. D. Holden and M. Klopp, entitled “Systems for Providing Services,” the entire subject matter of which is herein incorporated by reference.

### BACKGROUND OF THE INVENTION

1. Field of the Invention

The present invention relates to systems and methods for providing services to an industry, and more particularly to a business to business Web hub for facilitating interaction among suppliers, customers and service providers.

### BACKGROUND

Traditional commerce and e-commerce between companies and/or individuals often involves the use of specialized service providers to facilitate transactions. Currently, a company wishing to utilize a service provider or service providers must locate and identify a service provider that meets their particular needs, and coordinate the use of that service provider with their use of other service providers and other parties to the transaction. This traditional system is generally costly to implement and inefficient for conducting business and managing business relationships.

For example, companies in the chemical industry may wish to utilize the services of a financial services firm such as Dun & Bradstreet to learn the creditworthiness of a potential customer. Systems in the state-of-the art require a company to find and contact the financial services firm directly and establish a relationship with the financial services firm. This relationship must be managed in addition to all other relationships being managed by the company.

Another area of inefficiency for many industries relates to compliance with Federal and State regulations on the transportation, storage and disposal of goods. Service providers may be able to provide assistance in this regard, but require the managing of another relationship.

An improved system for facilitating and managing relationships between and among companies and service providers is needed.

### SUMMARY OF THE INVENTION

It is therefore an object of the invention to provide a system for facilitating and managing relationships between and among companies and service providers that seeks to minimize and overcome the problems and inefficiencies of traditional methods.

The systems of the present invention integrate services that are currently provided by multiple entities into a unified system that may be advantageously provided by a single entity to facilitate the buying and selling of services and products. An embodiment of the present invention, as a business to business (B2B) site on the World Wide Web (WWW), provides suppliers and customers in an industry with “one stop” to locate services that will facilitate their interactions. An embodiment of the systems of the present invention are particularly advantageous for use in providing services to the chemical industry.

A community of service providers, companies and partners interact with each other utilizing a hub-based model. In an embodiment of the present invention the community comprises an industry such as the chemical industry. The community, however, may exist on many levels and comprise an entire industry on one level and segments of that industry on other levels.

The community may be implemented as a “virtual” community, for example as a site on a computer network such as the World Wide Web; a corporate intranet; a government/military network or the like. Preferably, for ease of access to the widest number of participants, the virtual community is implemented as a site on the World Wide Web (Internet). Currently available hardware platforms, including PC's, Minicomputers and mainframes, and currently available operating systems, including UNIX®, Microsoft® Windows™, Apple Macintosh OS and Linux, may be utilized to host the site. In a preferred embodiment, the features discussed herein are implemented in XML (eXtensible Markup Language) software code. (Microsoft® and Windows™ are trademarks of Microsoft Corporation. UNIX® is a registered trademark of UNIX System Laboratories, Inc. Macintosh® is a registered trademark of Apple Computer, Inc.)

According to an embodiment of the present invention, a community is built by providing a central hub that provides at least an initial focal point for members of the community. The hub may comprise a server or servers that provide the functionality discussed herein. The hub will provide message formatting and other network services to facilitate interaction, and establish links among members of the community.

The hub may be provided by a member of the community as part of the members contribution to the community. A possible business model for the hub provider is a fee based model wherein the hub provider charges transaction, subscription, connection or other fees for facilitating interaction among members of the community.

At least initially, members of the community exist as spokes off of the hub. Over time, direct connections and networks are established among and between members of the community such that the hub and spoke model transforms into a neural network model including multiple interconnections. The hub may continue to exist however as a provider of the software engines that drive the overall network and transactions, as a service aggregator and also as an initial point of contact for new members of the community.

Members of the community may include one or more of the following: a hub provider; service providers; companies, including suppliers and customers; partners; and vertical market portals.

A hub provider may also be a member of the community in other respects, e.g. a company or service provider. The hub provider will assist in establishing the community and implementing the features described herein. The hub provider may continue to exist as a community member to provide support services to the community and participate in other aspects of the community.

Service providers may include providers of services routinely utilized in an industry. These services may include, but are not limited to: financial services; logistics and/or procurement services; health, safety and environmental services; e-commerce engine services; spot market services and others.

As a general matter, the service providers, and community members may include any service that is capable of being automated or otherwise codified in computer software.

Financial services may include providing financial information, settlement, credit checking and related services.

Logistic and/or procurement services may include transportation and shipping services, inventory tracking and the like. The logistic and/or procurement services may further include advanced planning and optimization services. A feature of the present invention is that the hub-based community may aggregate its demand for products or services in a manner that will lower costs to community members. Supply of products or services may be similarly aggregated.

Health, safety and environmental (HSE) services may include providing regulatory information relating to federal, state and international regulations that govern transportation, storage, disposal and other aspects of goods and services utilized by the industry. It is envisioned that the hub-based community will provide a “one stop” point for learning all regulations that affect, for example, the interstate transportation of goods. Another feature of the present invention is that the hub-based community may provide a service to allow automatic EPA (Environmental Protection Agency) filings by community members.

E-commerce engine services include providing e-commerce engines (software) that will facilitate the management of invoices, payment and other transaction details relating to transactions among community members. The e-commerce engine may also provide services to facilitate interaction among financial institutions and community members. A particular feature of the present invention is the translation of enterprise resource planning data from a community member into a form that may be seamlessly utilized by other community members.

Spot market services include auction-based services to allow community members to acquire or dispose of surplus inventory and the like.

Another objective of the present invention is that the hub-based community may include portals to vertical market sites relevant to a particular industry. The hub-based community may also connect vertical market sites relevant to a particular industry and establish networks among the sites and community members.

An example of a vertical market portal is described in the commonly assigned U.S. Provisional patent application Ser. No. 60/189,156, entitled, “Vertical Systems and Methods for Providing Products and Services,” filed on Mar. 14, 2000, by R. Tambay. The disclosure of the “Vertical Systems and Methods for Providing Products and Services” is hereby incorporated herein by reference. Other vertical markets sites could include for example “coatings.com,” “resins.com,” “bottles.com” and “storefront.com”.

Company members of the community include suppliers and customer of goods and services utilized by an industry. For example, in an embodiment of the present invention in the chemical industry, a chemical manufacturer may be a company member of the community and the chemical manufacturer's customers may also be company members. As will be appreciated from the disclosure herein, company members may also provide services to members of the community and therefore take the additional role of service providers.

Embodiments of the present invention may include partners as members of the hub-based community. The partner may be a community member who participates in some fashion in the set-up and/or maintenance of the hub. Partners may also be service providers or company members of the Web.

Another object of the invention is to provide a method for facilitating and managing relationships between and among business entities forming a community. According to the invention, a hub having one or more servers providing standard message formats and an open integration architecture, and network servicing component, is established for integrating entities within the community. A plurality of entities are then integrated with the hub via a plurality of pathways using the hub's standard message formats and open integration architecture. The entities then communicate with one another through the hub. In one embodiment, additional connections, or pathways, may be created over time to connect the entities directly, in addition to being connected through the hub.

### BRIEF DESCRIPTION OF THE DRAWINGS

The accompanying drawings, which are incorporated in and form part of the specification, illustrate preferred embodiments of the present invention and, together with the description, disclose the principles of the invention. In the drawings:

FIG. 1 shows a representation of a typical company/customer relationship;

FIG. 2 shows a representation of the company/customer model using XML (eXtensible Mark-up Language) to extend the B2B relationship;

FIG. 3 shows a representation of the company/customer model with partners and suppliers;

FIG. 4 shows a representation of the hub-centric approach of the present invention;

FIG. 5 shows a representation of the hub-centric approach of the present invention with Partners linked directly between themselves;

FIG. 6 shows vertical markets linked to the hub;

FIG. 7 shows an embodiment of a computer system in accordance with the present invention, including an internet user and an application service provider;

FIG. 8 shows an embodiment of a virtual catalog hub as well as steps carried out in a process in accordance with the present invention; and

FIG. 9 shows an embodiment of a computer system in accordance with the present invention, including an application service provider and an ERP system of a market participant.

### DETAILED DESCRIPTION OF THE INVENTION

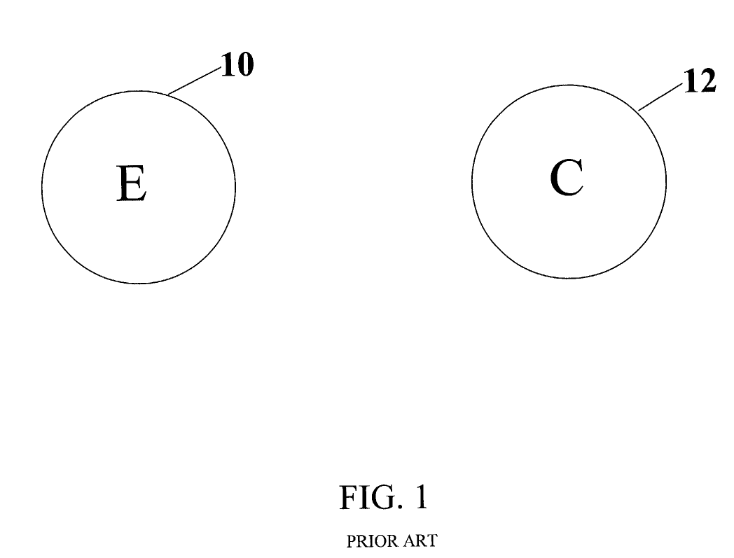

Referring now to the drawings, and in particular to FIG. 1, there is shown a representation of a typical company/customer relationship. Company “E” 10 is shown as a distinct entity from Customer “C” 12. Internet technologies expose inefficiencies in conducting business and managing business relationships via traditional methods. Traditional EDI (electronic data interchange) between a company 10 and customer 12 is expensive and difficult. EDI has been applied successfully to only a small fraction of the opportunity of business-to-business (B2B) integration.

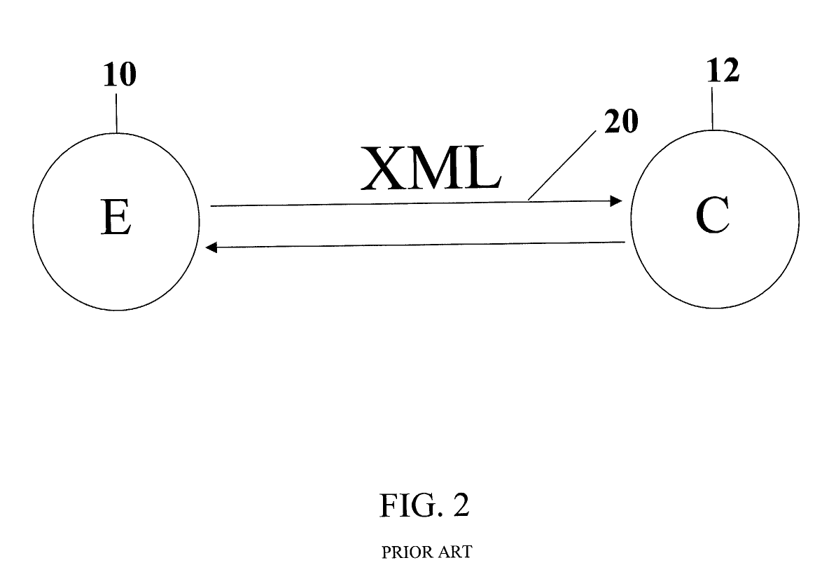

FIG. 2 shows a representation of the company/customer model using XML to extend the B2B relationship. XML is often used for enabling and extending B2B relationships on the Internet. A pathway 20 connects the company 10 with the customer 12. Modern back office systems offer APIs (application programming interfaces) that expose their functionality. XML is the “computer language” that allows these APIs to commnunicate; thus, enabling system-to-system integration. Without standardization, XML requires that the APIs be mapped as XML messages sent through the pathway 20 and the workflow defined on a partner-by-partner basis.

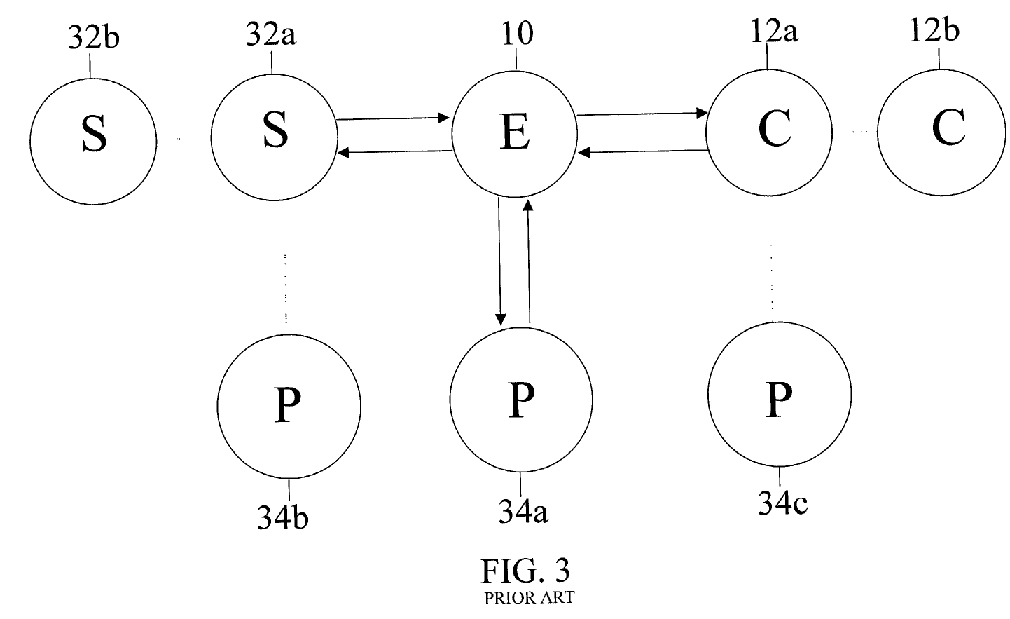

FIG. 3 shows a representation of the company/customer model with partners and suppliers. Delivering the XML solution to every customer 12, supplier 32, and partner 34, though much easier than with EDI, requires some duplication of effort. For instance, initially company 10 is integrated with supplier 32a, partner 34a and customer 12a. Customer 12b, supplier 32b, and partners 34b and 34c are desired as part of the entire B2B solution. The pathways between and among the company, customers, partners and suppliers will need to be created for each connection. Moreover, this solution will not allow the individual company 10 to extend its influence up, down, or across the value chain.

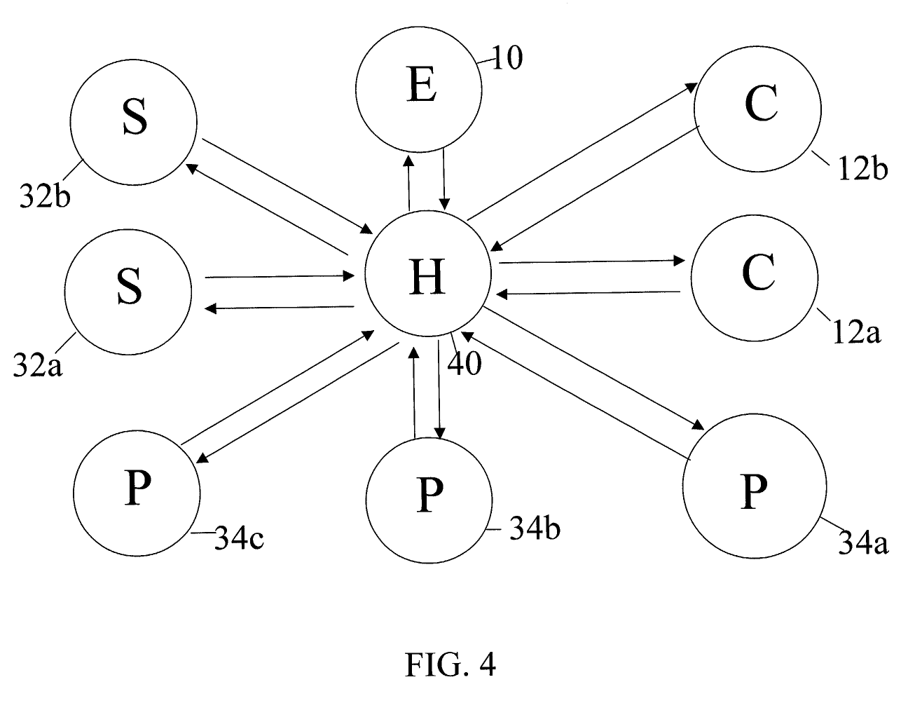

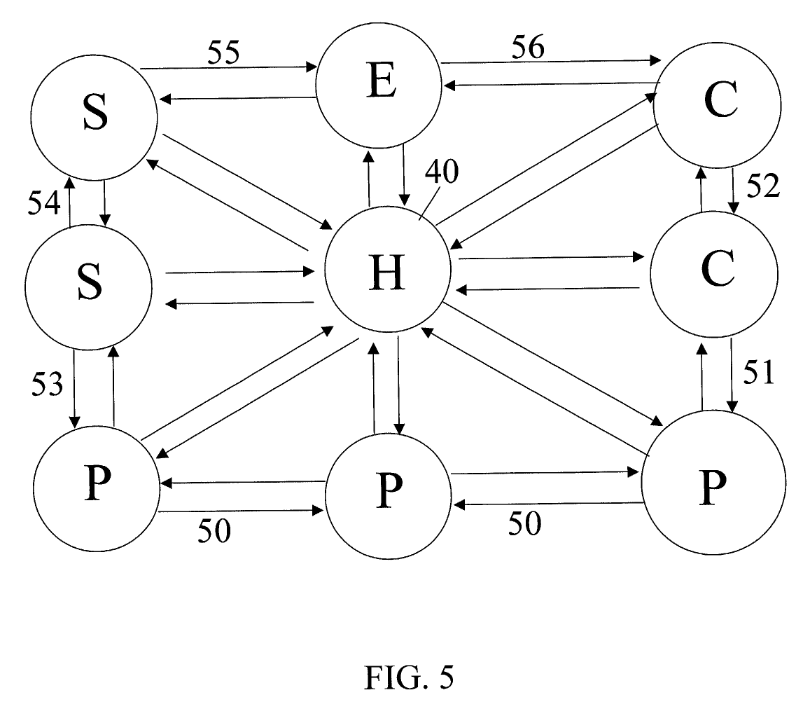

The present invention uses a hub-centric approach, rather than an individual company-centric approach. Thus, all partners could look to the hub to provide a source for integration standards. In this way, each partner would gain access to the entire community by integrating once with the hub rather than with each partner individually. Referring to FIG. 4, there is shown a representation of the hub-centric approach. The hub 40 is integrated directly to the company 10, customers 12a and 12b, partners 34a, 34b and 34c, and suppliers 32a and 32b. Partners can then build links directly between themselves as shown in FIG. 5.

An embodiment of the invention may also comprise other instances of systems connectivity. The systems connectivity will lead to more efficient transactions by providing a conduit for business-to-business (B2B) commerce. Referring now to FIG. 5, the open integration and XML message format standards as found on the hub 40 are used to integrate partner-to-partner 50, partner-to-customer 51, partner-to-supplier 53, customer-to-customer 52, supplier-to-supplier 54, supplier-to-company 55, and company-to-customer 56 pathways. The implementation of the hub connectivity between and among entities in the industry (e.g., partners, suppliers, companies, etc.) enables the connectivity between Community-Building Services, Content/Value-Added Services, Commerce-Enabling Services, and other vertical or horizontal market entities.

In a preferred embodiment, the hub is implemented using commercial-off-the-shelf (COTS) technology available from webMethods, Inc. of Fairfax, Va. In the preferred embodiment, the webMethods® B2Bi Solution Suite software is used. The webMethods® B2Bi Solution Suite's infrastructure automates business processes within an enterprise and with selected customers and trading partners over the Internet. Based on open standards, the B2Bi Solution Suite is capable of linking existing enterprise resource planning (ERP), financial, CRM, mainframe and other systems inside an enterprise. This infrastructure is reliable and secure and capable of extending links across firewalls, making it possible to implement, manage and maintain e-business relationships with thousands of trading partners. It would be apparent to one skilled in the art that other B2B integration solutions could be developed or modified to implement the hub of the present invention. (webMethods® is a registered trademark of webMethods, Inc.)

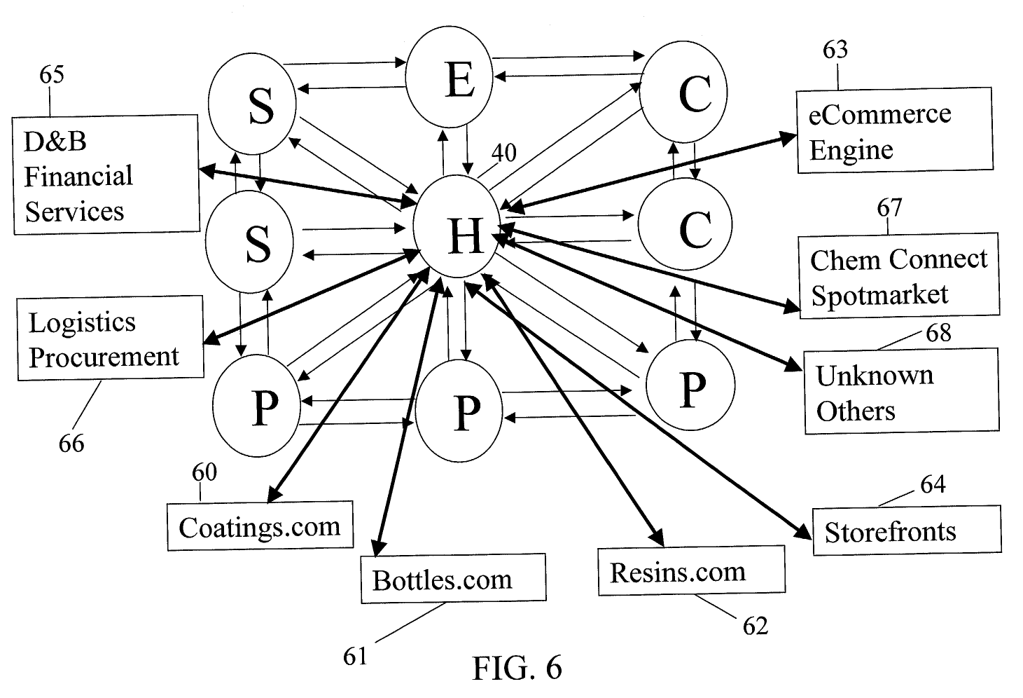

The hub expresses itself on the Web as a series of market-specific verticals around which communities are built. For instance, FIG. 6 shows vertical markets linked to the hub. In an embodiment in the chemical industry, examples of vertical markets could be implemented as coatings.com 60, bottles.com 61, and resins.com 62. An e-commerce engine 63 enables transactions with the vertical markets through the hub 40. The e-commerce engine 63 is a service available from the hub. The e-commerce engine 63 also provides the ability to host storefronts 64 for all partners in the community. Alliances are built with Web and Internet-based services 65, 66, 67 and 68 expressed as both XML, on the hub 40, and HTML (HyperText Mark-up Language), on the verticals to serve the various vertical markets 60, 61 and 62. The traditional customers 12, suppliers 32, and partners 34 also bring service offerings to the hub.

As illustration, in an embodiment of the present invention the hub contains vertical markets for the chemicals industry. This illustration utilizes the invention as disclosed in U.S. Provisional patent application Ser. No. 60/189,156, entitled “Vertical Systems and Methods for Providing Products and Services,” supra. This embodiment of the present invention will provide many advantages to suppliers and manufacturers in the paints and coatings industry. Participants in the paint and coatings segment of the chemicals industry are actively seeking out partners, alliances and vendors to increase the transparency and thereby the efficiency of their market. Price increases have been difficult to obtain from the end-users of paints and coatings and therefore, the suppliers and manufactures must reduce their procurement, manufacturing and selling costs to elevate or sustain profit margins. Value in the paint and/or coatings segment has been migrating toward the powerful end-users and super retailers. The paint and/or coating segment has a strong need for a segment-focused, e-procurement solution that (1) enables a more efficient buying process, reducing sales, marketing, customer service and administration costs, and (2) provides access to a full range of products and services, simplifying the formulation of new paints and coatings.

In an embodiment of the present invention, the paint and coating segment of the chemicals industry is implemented through a web site, for example, “coatings. com”. From within the five product categories that make up the essential raw materials for paint and/or coatings manufacturers, additives are both highly strategic products and highly fragmented. Therefore, coatings.com focuses on providing a very broad additives product line to this industry and provide transactional efficiencies for this category, then scale to other products and services as needed by the community.

Coatings.com provides a digital marketing channel for formulation products and services. Coatings.com's product/service offerings fall into three broad categories: community, content/value-added and commerce as described below.

Coatings.com has an initial focus on the approximately $2 billion worldwide coatings additives product category, as the fragmentation and higher margins of this segment allow for greater value add through the aggregation of a rich product and content offering. Focus in this high-value area, critical to all paint and/or coatings formulation, provides the a differentiator for accelerating significant traction for the coatings.com community. Once this transaction-based community has been developed, it can be is expanded to meet additional needs of the paint and/or coatings industry as well as the adhesives and/or sealants industry.

Coatings.com relies on three distinct categories as its major sources of revenue: transaction revenues; revenues from services; and information based revenues.

Transaction revenues are commission fees charged to sellers and based on the degree of value provided to these users. The initial fee will be based on benchmarking with other comparable business models in similar industrial e-marketplaces, and is competitively advantaged over the current off-line channel. It is expected that the transaction revenues be one of the earliest sources of revenues and as a result of the eCommerce functionality but one where margin sustainability may be eroded over the short period. Over time, as the company's service offering and information offering becomes broader and deeper, it is expected that transaction fees be increased due to the degree of total value to users.

In a further embodiment, community-building services bring valuable information to the community that is currently difficult to obtain. This list includes but is not limited to the following: editorial reviews and industry news; career center; industry manuals, books and publications; discussion forums; FAQs (frequently asked questions); new technology showcase; regulatory information by state and country; software application download library; trade association information and events calendars; market information, business intelligence reports; industry information such as housing starts, construction trends, global news; and end-use customer product demand.

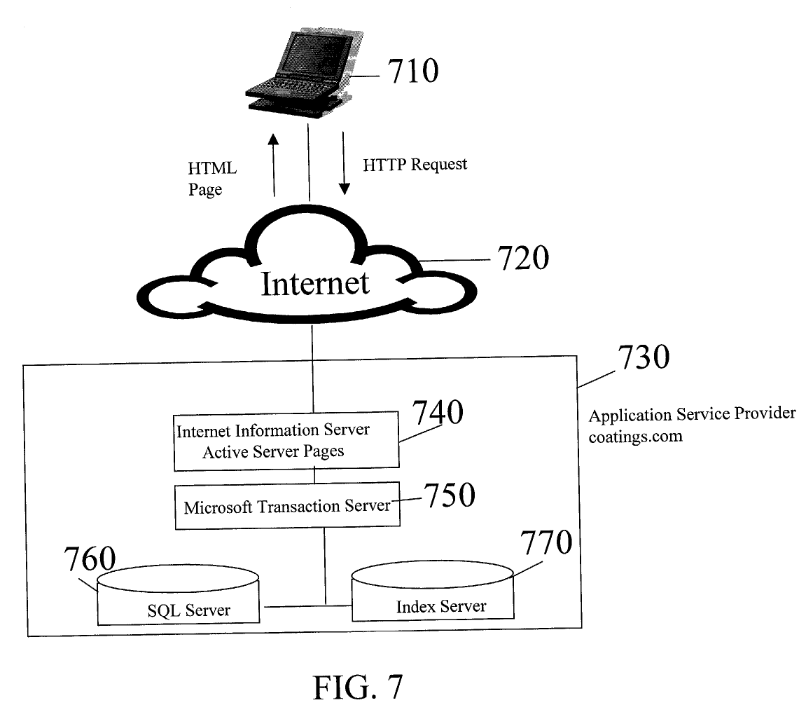

In one embodiment, an application service provider (ASP) hosts coatings.com on a web server. Referring to FIG. 7, the user 710 accesses the Internet 720 and specifies the uniform resource locator (URL) for coatings.com (web site). The request is routed to the ASP 730, specifically to a web site, running under, for example, Microsoft Internet Information Server™ (IIS) 740, that the ASP has bound to the coatings.com domain name. The user specifies identification information through entry an HTML form and this information is posted, using a secure method such as secured sockets layer (SSL), to the web site.

When the web site receives the identification information, a web server-based environment such as java server pages or Microsoft® Active Server Pages™ (MSASP) receives the posted information. The MSASP instantiates an object running under an object request broker (ORB). Under one embodiment, the object that is instantiated conforms to the Common Object Modeling (COM) standard and is managed by Microsoft® Transaction Server (MTS) 750, but one skilled in the art could also utilize objects conforming to Object Management Group's (OMG) Common Object Request Broker Architecture (CORBA) or other ORB and remote procedure call (RPC) architectures.

The object receives the request and uses processing rules to formulate a response. When the object that handles user identification receives information from the MSASP, the object searches a database to confirm the identity of the user. In one embodiment of the invention, the database is managed by Microsoft® SQLServer 760. In addition to confirming the identity of the user, the object retrieves additional information, including the industry(s) and market segment(s) that are of interest to the user.

The object may search the same database or additional databases as well as document repositories for information that is relevant to the identified industry(s) and market segment(s). In one embodiment of the invention, the document repository is managed by Microsoft® Index Server (MSIS) 770.

The MSASP combines all the information retrieved from the various data sources into a extensible markup language (XML) document and associates the XML document with a style sheet (XSL), producing a hyper-text markup language (HTML) page for presentation to the user. The HTML page can contain excerpts from various articles and other sources of information as well as hyperlinks for access to the entire documents.

In a further embodiment, content/value-added services include but are not limited to those offerings that facilitate the work processes for formulators. Examples of these include the following: sample services; material safety data sheets; starting-point formulas; solvent formulation program wizard; polyester (resin) formulation program wizard; training and education; and an “ask the expert” problem-solving function.

In one embodiment of the invention, access to these services is provided on an HTML page generated with an MSASP. The service itself may be provided by either a client-side or server-side program. In one embodiment, a specific service consists of an HTML form. Referring again to FIG. 7, a user 710 enters the required information on a form and submits the form to the web site at the ASP 730. The MSASP under IIS 740 processes the request and, if necessary, instantiates an object under MTS 750. The object performs the processing logic for the service. If necessary, the object queries a database 760 for necessary information and then the object responds to the MSASP. The MSASP continues processing, creating an HTML page for the user and sending the document to the user.

An embodiment of the invention can also present training and education services to the user. A series of training topics for which material has been previously prepared may be indexed. The indexing process includes relating the training material to various industries and market segments. When the database or document repository is searched by a user, the access to the relevant training topics is included on the resultant HTML page.

In a further embodiment, commerce-enabling services will be geared towards facilitating the procurement of goods and services for this industry. This list includes the following: Multi-vendor exhaustive product catalog and storefronts; eCatalog hub for additives and specialty products bought on a regular basis; Liquid exchange for high volume commodities bought on a regular basis; Customer-specific pricing functionality; RFQ for infrequent or 1-off purchases, typically for operating supplies; MRO (maintenance, repair and operations) offering for systematic sourcing of operating supplies; eVendor Managed Inventory; Systems connectivity for reduction in transaction costs; Surplus auction capabilities; Company business rule customization; “My purchasing Assistant” intelligent agent. The starting point of the commerce offering will be an e-catalog for the procurement of additives and other specialties. This is due to the customer-stated need for a procurement solution for these repetitive low volume, high dollar purchases that consume a high amount of time and energy.

The ability to easily and efficiently purchase goods and services directly from an ecommerce online storefront is critical to the success of the online storefront. When the procurement process is complex, as in the chemical industry, commerce-enabling services that provide more than the simple ability to sell and purchase goods are also critical. An embodiment of the invention addresses this critical need by providing industry or market segment-specific e-Commerce-enabling services.

The embodiment includes a product catalog and an online storefront. The product catalog comprises products from multiple vendors. The vendors exist at all levels of the supply chain, including for example feedstock producers, manufacturers and supporting participants such as consulting firms.

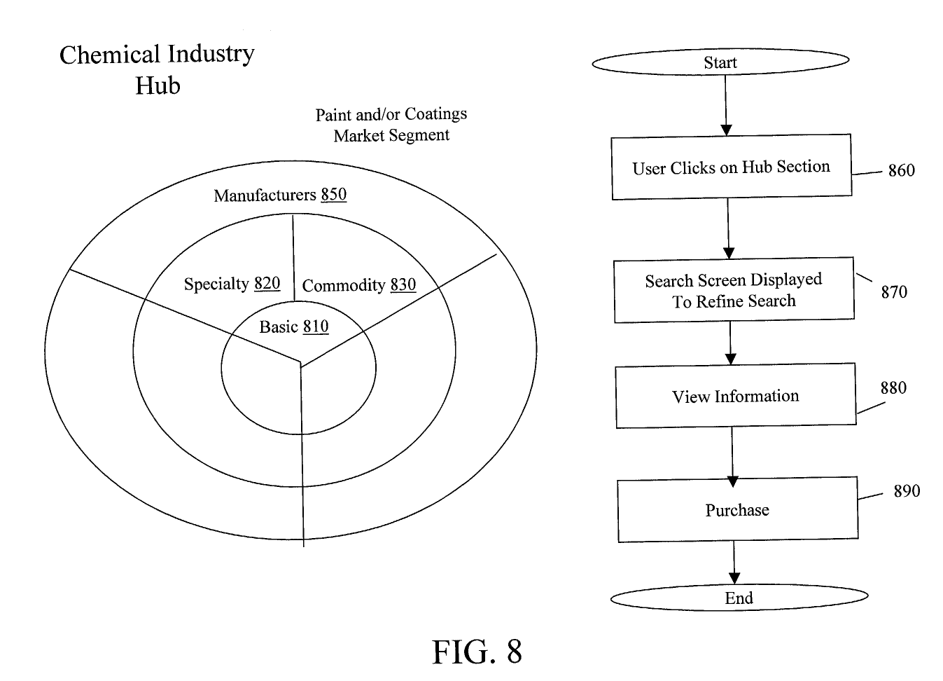

Referring to FIG. 8, an embodiment of the invention includes an eCatalog hub for additives and specialty products bought on a regular basis. The eCatalog hub is a virtual representation of the supply chain for the industry or market segment presented as concentric circles representing various levels of the supply chain and spokes representing divisions between various market segments of an industry. The innermost rings of the hub comprise the lowest level of the supply chain such as the basic chemicals supplied by feedstock producers 810. Visually progressing towards the outside of the hub, the next ring comprises the specialty 820 and commodity 830 chemical suppliers. Finally, the outer ring comprises manufactured products 850. A user may click on any section of the hub to identify the subset of products and services that are of interest to that user 860. Once the user has selected the subset, the embodiment presents the user with an HTML page that allows the user to further refine the product and service search 870. When the user submits this form, the user can perform other standard commerce functions such as purchasing a product 890 or viewing product information 880.

An embodiment of the invention also includes several services that enable the user to procure products and services in a highly efficient, automated manner. An example of such a service is a Liquid Exchange for high volume commodities. A user can specify that periodic purchases be made automatically under a pre-defined set of specifications. Another example is a customer-specific pricing functionality. The price for a specific product is determined automatically based on a number of factors, including the purchase history of the customer and the volume of the purchase.

Also, an embodiment of the invention may include a surplus auction service to increase the efficiency of the commerce transactions occurring on the web site. A user makes an original quantity of a product available for sale as a batch. The user is then presented with the option of allowing a purchase of less than the original amount and a further option to automatically auction any surplus, or the difference between the purchase quantity and the original quantity made available for sale. If the user chooses a surplus auction, the user may further specify attributes of the auction such as a reserve price. The product batch is marked as allowing a surplus auction. If a buyer then purchases less than the total batch, the surplus is automatically made available for sale by auction. The attributes of the auction are as originally specified by the seller.

An embodiment of the invention includes an intelligent agent service, “My Purchasing Assistant,” (purchase agent service) to further increase the efficiencies of the commerce transactions on the web site. The purchase agent service allows the user to enter a set of parameters regarding a purchase to be made in the future. These parameters may include but are not limited to: the beginning and ending date within which the service is active, the desired product or service, the acceptable supplier and the price at which the purchase should be triggered. The purchase agent service initially provides the user with a plurality of purchasing parameters in an HTML form. The user sets parameters by entering data directly or by selecting elements from a finite list such as in a drop-down combo box. The user submits the form to the web site and the MSASP that processes the form creates an entry in a database. Later, a seller makes a batch of product available for sale at a specific price.

The system evaluates any agents which are stored in the database to determine if the triggering parameters associated with the agent are satisfied. If so, the user who initiated the purchasing agent service is informed by email that a product batch meeting the user's set of parameter is available. Once the user has information regarding the product batch that is available, the user may decide to purchase the batch. Other embodiments of the invention might include the ability to automatically complete the purchase with no interaction from the user other than the initial entry of the purchase agent service parameters.

An embodiment of this invention includes further services to increase the efficiency of transactions within an industry or market segment. One such service is a request for quotation (RFQ) service for infrequent purchases. The prospective purchaser can submit a request detailing the specifications or the required product or service. Sellers who can provide the desired product or service can respond with a quotation, including a price. The buyer and seller can then complete the transaction on-line.

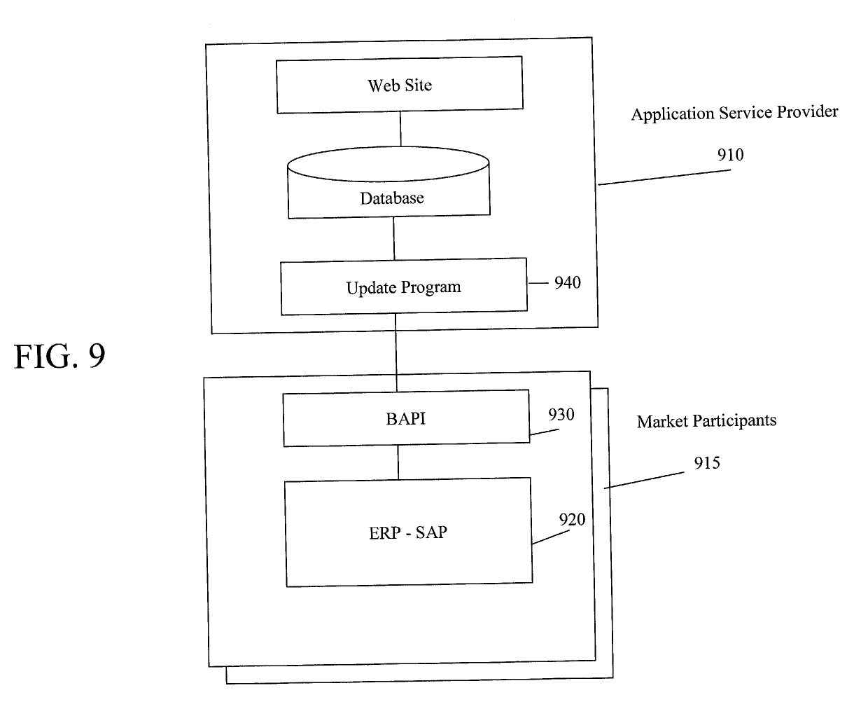

An embodiment of the invention can further increase transparency and efficiency within the industry or market segment through systems integration with the market participants. As shown in FIG. 9, an embodiment of the invention may contain a web site and a corresponding database on an ASP 910. The database contains inventory information regarding market participants 915. It is critical that inventory information on the electronic storefront reflects the current state of inventory for the market participant.

Generally, a market participant will have a software application for managing inventory. Medium to large businesses generally have an enterprise resource planning (ERP) system such as SAP or BAAN 920. In addition to inventory and sales information, an ERP system may also include manufacturing, distribution, financials and personnel information. Many ERP systems contain remote procedure call (RPC) services to allow an external application to access functions within the ERP system. SAP includes a Business Application Programming Interface (BAPI) 930 to support this functionality. In an embodiment of the invention, a computer program is periodically executed on the ASP server 940. The update program initializes an RPC to a BAPI in the market participant's SAP instance 930. The BAPI returns the inventory information of the market participant, and the update program updates the database for the shared catalog with the inventory information.

The hub method has significant commercial value. There is potential value capture through Internet valuation, revenue streams from service offerings and from storefronts. The hub provides potential value capture through: advertisement revenue from vertical portals; rent from storefronts; transaction fees from storefronts; a cut from the service offerings; membership fees; subscription fees; and B2B server up sells.

The hub approach succeeds where current methods fail because current vertical market approaches do not support deep integrated direct relationships between buyers and sellers; buyers and sellers will have incentive to build integrated relationships to avoid transaction fees with third parties; it provides a platform for truly value added Web-based services; and it provides for value capture opportunity by all partners in a trading community. An embodiment of the invention may also comprise other instances of systems connectivity. The systems connectivity will lead to more efficient transactions by providing a conduit for business-to-business (B2B) commerce.

It should be understood that the embodiments described in this document are not meant to limit the scope of the present invention rather merely provide additional details that will be understood of those of ordinary skill in the art about possible implementations of the present invention.

1. A system for facilitating and managing relationships between and among business entities forming a community, comprising:
a hub comprising at least one server providing standard message formats and an open integration architecture, network servicing component; and
a plurality of entities, wherein each entity desires interaction with at least one other entity, and each entity is connected to the hub via a pathway using the hub's standard message formats and open integration architecture, wherein the hub facilitates interaction and establishes links between and among the plurality of entities.

2. A system for facilitating and managing relationships between and among business entities, as recited in claim 1, wherein the standard message formats used by the hub and the plurality of entities are coded in Extensible Mark-up Language (XML).

3. A system for facilitating and managing relationships between and among business entities, as recited in claim 1, wherein an entity is selected from the group consisting of a company, a customer, a supplier, a partner, a hub provider, a service provider, and a vertical market portal.

4. A system for facilitating and managing relationships between and among business entities, as recited in claim 3, wherein the plurality of entities connected to the hub form an integration between and among vertical markets sites relevant to a particular industry.

5. A system for facilitating and managing relationships between and among business entities, as recited in claim 1, wherein at least one entity connected to the hub is also connected to at least one additional entity, the additional entity being connected to the hub, thereby adding an additional level of connectivity in the community.

6. A system for facilitating and managing relationships between and among business entities, as recited in claim 1, wherein the community is implemented on a proprietary intranet.

7. A system for facilitating and managing relationships between and among business entities as recited in claim 1, wherein the community is implemented on a public, global computer network.

8. A system for facilitating and managing relationships between and among business entities, as recited in claim 1, wherein the hub is provided by an entity in the community.

9. A system for facilitating and managing relationships between and among companies and service providers, as recited in claim 8, wherein the hub providing entity collects a fee for hub usage by other members of the community.

10. A system for facilitating and managing relationships between and among business entities, as recited in claim 1, wherein at l east one entity in the community entity is a service provider selected from the group consisting of a financial service provider, a logistics service provider, a procurement service provider, a health, safety and environmental service provider, an e-commerce engine service provider, and a spot market service provider.

11. A system for facilitating and managing relationships between and among business entities, as recited in claim 10, wherein services provided by a financial services provider comprise providing financial information, performing credit checks, and related services.

12. A system for facilitating and managing relationships between and among business entities, as recited in claim 10, wherein services provided by logistics and/or procurement service providers comprise transportation and shipping services, and inventory tracking services.

13. A system for facilitating and managing relationships between and among business entities, as recited in claim 10, wherein services provided by health, safety and environmental (HSE) service providers comprise providing regulatory information relating to federal, state and international regulations.

14. A system for facilitating and managing relationships between and among companies and service providers, as recited in claim 1, wherein an entity in the community is a service provider capable of being automated or codified in computer software.

15. A method for facilitating and managing relationships between and among business entities forming a community, comprising:
establishing a hub for integrating entities within the community, the hub having one or more servers providing standard message formats and an open integration architecture, and network servicing component;
integrating a plurality of entities with the hub via a plurality of pathways using the hub's standard message formats and open integration architecture, wherein each entity desires interaction with at least one other entity and communicates with other entities in the community through the hub.

16. A method for facilitating and managing relationships between and among business entities forming a community, as recited in claim 15, further comprising:
enabling an entity in the community to form a pathway directly to a second entity in the community using the standard message formats used by the hub.

17. A method for facilitating and managing relationships between and among business entities forming a community, as recited in claim 16, further comprising:
providing, by a service provider, services to one or more entities within the community, wherein the service provider and a service receiver are connected directly.

18. A method for facilitating and managing relationships between and among business entities forming a community, as recited in claim 16, further comprising:
providing, by a service provider, services to one or more entities within the community, wherein the service provider and a service receiver are connected through the hub.

19. A method for facilitating and managing relationships between and among business entities forming a community, as recited in claim 16, wherein at least one entity in the community is a service provider.
